(19) United States
(12) Patent Application Publication
(10) Pub. No.: US 2005/0089603 A1
(43) Pub. Date: Apr. 28, 2005

(54) Low carbohydrate food product and method of making the same

(76) Inventor: James D. Krol, Moline, IL (US)

Correspondence Address: BREINER & BREINER, 115 NORTH HENRY STREET, P. O. BOX 19290, ALEXANDRIA, VA, 22314, US

(21) Appl. No.: 10/692,857

(22) Filed: Oct. 27, 2003

(51) Int. Cl. A23G 3/00

(52) U.S. Cl. 426/94

(57) ABSTRACT

The present invention is a new low carbohydrate food product and method of making the same. Specifically, the present invention is a low carbohydrate crustless pizza and a method of making the same, such that the low carbohydrate crustless pizza exhibits a texture, flavor, consistency and handleable character similar to a traditional pizza made with a high carbohydrate pizza dough crust.

### FIELD OF INVENTION

The present invention relates to a new low carbohydrate food product and method of making the same. Specifically, the present invention is a low carbohydrate crustless pizza and a method of making the same, such that the low carbohydrate crustless pizza exhibits a texture, flavor, consistency and handleable character similar to a traditional pizza made with a high carbohydrate pizza dough crust.

### BACKGROUND OF INVENTION

Pizza has become one of America's most favorite foods over the last several decades. Specifically, millions of pizzas are sold and consumed each day in the United States alone. A typical pizza consists of a dough crust bottom layer, a tomato sauce layer, a cheese layer and optionally, various toppings including assorted meats and vegetables.

Even though pizza has become one of America's most favorite foods because of its appetizing and savory taste, typical pizzas tend to be high in carbohydrates. Carbohydrates are a recommended portion of a general balanced diet since carbohydrates provide energy, are an ideal fuel source for a person and play an important role in the structure and function of the body's organs and nerve cells. However, a carbohydrate intake that is too high can lead to an undesired weight gain if a person does not perform a sufficient amount of exercise to burn those carbohydrates. Excess carbohydrates in a person's diet may also cause or increase a person's chances of developing other health problems such as vascular disease, chronic hyperglycemia and diabetes.

In an effort to decrease and prevent weight gain and to manage and prevent health related problems, many people are trying to change the way they eat and the types of foods they eat. However, many people are unsuccessful on their own or without the aid of a personalized nutrition and exercise plan, which can be very expensive. However, many diets have been developed by medical professionals and others to help people in managing their weight and health related problems. Many of these diets tend to consist of a low carbohydrate, high protein and moderate caloric intake.

One of the most difficult problems in maintaining a high protein, low carbohydrate diet is the fact that many foods that people crave and enjoy eating, such as pizza and snack foods, are high in carbohydrates and fats and low in protein. As a result, a trend has developed in trying to make traditionally high carbohydrate foods into low carbohydrate foods. However, the disadvantage with many of these “new” low carbohydrate foods is that they are not as appetizing as the original high carbohydrate foods or not even appetizing at all. As such, many of these “new” low carbohydrate foods do not satisfy the craving for the traditional high carbohydrate foods.

The low carbohydrate crustless pizza and a method of making the low carbohydrate crustless pizza of the present invention resolves the disadvantages associated with the low carbohydrate diets and foods described above.

### OBJECTS AND SUMMARY OF THE INVENTION

The present invention relates to a new low carbohydrate food product and method of making the same. Specifically, the present invention is a low carbohydrate crustless pizza and a method of making a low carbohydrate crustless pizza, such that it has a texture, flavor, consistency and handleable character similar to a traditional pizza made with a high carbohydrate pizza dough crust.

The low carbohydrate crustless pizza of the present invention does not contain a dough layer as does a traditional pizza. A dough layer in a traditional pizza is generally a mixture that consists essentially of flour or meal and a liquid, such as water or milk, and is stiff enough to knead or roll.

Instead, the pizza of the present invention has a base layer which is comprised of a formulated flour (dry ingredients) and a cheese mixture. Optionally, another food product may be added to the base layer mixture. For example, a traditional meat topping or combination of meat toppings may be added to the base layer mixture. Additionally, another food product such as a soy enriched topping, a poultry, a fish, a vegetable, a fruit and any combination thereof, may be added to the base layer mixture instead of, or in addition to, a traditional meat topping as an optional ingredient.

The base layer mixture is then placed onto a suitable cooking pan by evenly distributing a pre-measured amount of the formulated flour (dry ingredients) onto the cooking pan and then evenly distributing a pre-measured amount of the cheese on top of the formulated flour. At least one additional layer selected from the group consisting of pre-measured amounts of cheeses, meat toppings, poultry toppings, fish toppings, vegetables, other suitable toppings and any combination thereof may then be added on top of the base layer mixture. A pre-measured amount of tomato sauce may also be added as an at least one additional layer or it may be served as an optional side item with the pizza.

The pizza may then be baked for a suitable time and at a suitable temperature. When baking is complete, the pizza may then be cooled to a suitable temperature, cut into slices and served. The pizza may optionally be packaged and served in a traditional take-out manner if the pizza is to be consumed in a location other than where it is baked.

The pizza may also be consumed at a time later than when it was baked. If the pizza is not going to be consumed immediately after baking, the pizza may be frozen until a desired time. After the pizza has been frozen, it may be thawed under refrigeration and reheated at a low temperature for a suitable time in any suitable heating apparatus.

Whether the pizza is consumed immediately after baking or upon reheating after being frozen and thawed, the low carbohydrate crustless pizza of the present invention exhibits a texture, flavor, consistency and handleable character similar to a traditional pizza made with a high carbohydrate dough crust.

As such, a primary object of the present invention is to provide a crustless pizza that is low in carbohydrates.

Another primary object of the invention is to provide a low carbohydrate crustless pizza which exhibits a texture, flavor, consistency and handleable character similar to a traditional pizza made with a high carbohydrate pizza dough crust.

Another primary object of the invention is to provide an easy method of making a low carbohydrate crustless pizza so that the layers are heated in a desired manner so that the crustless pizza may be handled and eaten like a traditional pizza having a crust.

### DETAILED DESCRIPTION OF THE PREFERRED EMBODIMENTS

The present invention relates to a new low carbohydrate food product and method of making the same. Specifically, the present invention is a low carbohydrate crustless pizza and a method of making the low carbohydrate crustless pizza, such that it has a texture, flavor, consistency and handleable character similar to a traditional pizza made with a high carbohydrate pizza dough crust.

The low carbohydrate crustless pizza of the present invention does not contain a traditional dough/crust layer as does a traditional pizza. A dough layer in a traditional pizza is generally a mixture that consists essentially of flour or meal and a liquid, such as water or milk, and is stiff enough to knead or roll.

Instead, the pizza of the present invention has a base layer which is comprised of a formulated flour (dry ingredients) and a cheese mixture. In a preferred embodiment, a batch of the formulated flour comprises a mixture of approximately 6 cups of flour, preferably high gluten flour, and approximately 2 tablespoons of double acting baking powder. The double acting baking powder traditionally includes a mixture of cornstarch, bicarbonate of soda, sodium aluminum sulfate and acid phosphate of calcium. The flour and double acting baking powder are then mixed well to make a batch of the formulated flour. A pre-measured amount of the batch of the formulated flour is used per pizza. This pre-measured amount of the batch of the formulated flour is preferably about one teaspoon per pizza. This amount and all amounts and weights hereafter are based on a pizza ranging in size from about 8 inches to about 16 inches. Then, a pre-measured amount of cheese may be evenly distributed on top of the formulated flour.

Optionally, another food product may be added to the base layer mixture. For example, a traditional meat topping, such as, but not limited to, pepperoni, sausage, bacon, ham or any combination thereof may be added to the base layer mixture. Additionally, another food product may optionally be added to the base layer mixture, instead of a traditional meat topping. In a preferred embodiment, this food product is preferably a food product such as, but not limited to (1) a soy enriched meat topping, (2) a poultry topping, (3) a fish topping, (4) a vegetable or fruit such as, but not limited to, peppers, onions, mushrooms, olives, artichokes, broccoli, spinach, tomato or pineapple or (5) any combination thereof. In a preferred embodiment, the additional food product which may be optionally added to the base layer mixture is present in a range from about 3 ounces to about 8 ounces, more preferably from about 4 ounces to about 8 ounces, most preferably from about 7 ounces to about 8 ounces.

To make the pizza of the present invention, the base layer mixture is placed onto a suitable cooking pan or cooking sheet by evenly distributing the pre-measured amount of the formulated flour onto a pan and then evenly distributing the pre-measured amount of cheese on top of the formulated flour. Optionally, a pre-measured amount of an additional food product may be evenly distributed on top of the cheese such that it is also a part of the base layer.

In a preferred embodiment, the cooking sheet or pan is any suitable cooking stone, preferably a stoneware pizza platter or pan.

At least one additional layer may be added on top of the base layer mixture. The at least one additional layer is preferably selected from the group consisting of cheeses, meat toppings, poultry toppings, fish toppings, vegetables, fruits, other suitable toppings and any combination thereof. Tomato sauce, i.e., pizza sauce, may also be added as an at least one additional layer or it may be served as an optional side item with the pizza.

A cheese which may be used as an additional layer in the pizza of the present invention is preferably a low moisture whole milk natural cheese product. The cheese is preferably selected from the group consisting of mozzarella, parmesan, provolone, cheddar, asiago, american, colby, monterey jack, feta, any other suitable cheese and any combination thereof. In a preferred embodiment, an amount of cheese may preferably be added in a range from about 3 ounces to about 8 ounces, more preferably from about 4 ounces to about 8 ounces, most preferably from about 7 ounces to about 8 ounces.

A meat topping which may be used as an additional layer in the pizza of the present invention is preferably selected from the group consisting of pepperoni, sausage, bacon, ham, soy enriched meat topping and any combination thereof. In a preferred embodiment, an amount of the meat topping may preferably be added in a range from about 3 ounces to about 8 ounces, more preferably from about 4 ounces to about 8 ounces, most preferably from about 7 ounces to about 8 ounces.

A vegetable or fruit topping which may be used as an additional layer in the pizza of the present invention is preferably selected from the group consisting of peppers, onions, mushrooms, olives, artichokes, broccoli, spinach, tomatoes, pineapple and any combination thereof. In a preferred embodiment, an amount of a vegetable or fruit topping may preferably be added in a range from about 2 ounces to about 6 ounces, more preferably from about 3 ounces to about 6 ounces, most preferably from about 4 ounces to about 6 ounces.

Once all of the desired layers are assembled, the pizza may then be baked for a suitable time and at a suitable temperature. In a preferred embodiment, the pizza is preferably baked in a suitable pizza oven or conventional gas or electric oven. The pizza may be baked for a suitable time ranging from about 9 minutes to about 13 minutes, more preferably from about 9 minutes to about 12 minutes, most preferably from about 10 minutes to about 12 minutes. The pizza may be baked at a suitable temperature ranging from about 450 degrees Fahrenheit (° F.) to about 525° F., more preferably from about 450° F. to about 500° F., most preferably from about 470+ F. to about 480° F.

When baking is complete, the pizza may then be cooled until its internal temperature is at a suitable and desirable temperature for consumption ranging from about 130° F. to about 150° F., more preferably from about 135° F. to about 145° F., most preferably from about 138+ F. to about 142° F. The pizza may then be cut into slices and served. The pizza may alternatively be packaged and served in a traditional take-out manner if the pizza is to be consumed in a location other than where it is baked.

The pizza may also be consumed at a time later than when it is baked. If the pizza is not going to be consumed immediately after baking, the pizza may be frozen until a desired time. After the pizza has been frozen, it may be thawed under refrigeration and reheated at a low temperature for a suitable time in any suitable heating apparatus. In a preferred embodiment, the pizza may be reheated at a low temperature setting for a time ranging from about one minute to about five minutes in a microwave oven. Alternatively, the pizza may be reheated in a preheated conventional gas or electric oven at a temperature ranging from about 175° F. to about 350° F., more preferably from about 225° F. to about 275° F., most preferably from about 245° F. to about 255° F., and for a suitable time ranging from about 2 minutes to about 5 minutes, more preferably from about 2 minutes to about 4 minutes, most preferably from about 2 minutes to about 3 minutes.

Whether the pizza is consumed immediately after baking or upon reheating after being frozen and thawed, the low carbohydrate crustless pizza of the present invention exhibits a texture, flavor, consistency and handleable character similar to a traditional pizza made with a high carbohydrate dough crust.

The pizza of the present invention, as described above, contains a low amount of carbohydrates as compared to the amount of carbohydrates in a traditional pizza. Specifically, a traditional cheese pizza has approximately twenty grams (20 gms) to thirty grams (30 gms) of carbohydrates per each 4 ounce serving. However, a pizza of the present invention comprising a base layer, a tomato sauce layer and an additional cheese layer only has approximately two and one-half grams (2.5 gms) to three and one-half grams (3.5 gms) of carbohydrates per 4.2 ounce serving of the pizza if a whole milk cheese is used. If a skim milk cheese is used, the carbohydrates per serving are reduced further, such that the pizza has approximately less than one gram (<1 gm) to two and one-half grams (2.5 gms) of carbohydrates per 4.2 ounce serving of the pizza. As such, the pizza of the present invention enables a person, especially those on a low carbohydrate diet, to enjoy the appetizing and savory taste of a traditional pizza and which satisfies the craving for a traditional high carbohydrate pizza without all of the carbohydrates contained in a traditional pizza.

Examples that follow are intended to illustrate the invention and not to limit the invention. All percentages and amounts used herein are by weight unless otherwise indicated.

### EXAMPLE 1

A low carbohydrate crustless pizza is prepared using the following components:

| | | |
|---|---|---|
| Formulated Flour Components | | |
| Flour (high gluten) | 6 | cups |
| Double acting baking powder | 2 | tablespoons |
| Pizza Components | | |
| Formulated flour (dry ingredients) | 1 | teaspoon (⅙ ounce) |
| Mozzarella cheese | 9.25 | ounces |
| (low moisture whole milk) | | |
| Tomato based pizza sauce | 1 | ounce |
| Mozzarella cheese | 8 | ounces |
| (low moisture whole milk) | | |

To make a batch of the formulated flour (dry ingredients), 6 cups of flour (high gluten) and 2 tablespoons of double acting baking powder are mixed thoroughly. One teaspoon (⅙ ounce) of the batch of the formulated flour (dry ingredients) is evenly distributed over a stoneware baking pan. Then, approximately 9.25 ounces of mozzarella cheese is evenly distributed over the formulated flour (dry ingredients). One ounce of a tomato based pizza sauce is then evenly distributed over the mozzarella cheese. An additional 8 ounces of mozzarella cheese is then evenly distributed over the tomato based pizza sauce. The pizza is then baked in a pre-heated conventional oven from about 475° F. to about 525° F. for about ten to fifteen minutes. The pizza is then cooled to an internal temperature of approximately 140° F. (approximately 10-15 minutes for cooling) and served.

NUTRITIONAL FACTS

| Ingredients | Amount of Carbohydrates |
|---|---|
| Flour (high gluten) | 22 grams per ¼ cup |
| Double acting baking powder | 0 (less than 1 gram) per |
| | 1 teaspoon |
| Formulated flour | less than 1 gram per 1 |
| (dry ingredients) | teaspoon (⅙ ounce) |
| Low moisture whole milk | |
| natural mozzarella cheese | |
| 33.25 ounces | 19.6 grams |
| 4.2 ounce serving of pizza | 2.5 grams |
| Pizza sauce (tomato base) | |
| (including tomato puree, | |
| water, tomato paste, | |
| less than 2% of salt, | |
| citric acid, spices, | |
| tomato fiber, natural | |
| flavors) | |
| 1 ounce | 2.675 grams (per pizza) |
| 4.2 ounce serving of pizza | less than 1 gram |
| TOTAL: | |
| Pizza (prepared) | |
| 4.2 ounce serving of pizza | approx. 2.5 grams-3.5 |
| | grams |

### EXAMPLE 2

A low carbohydrate crustless pizza is prepared using the components of Example 1 with the addition of the following components:

Pizza Components (additional)

| | |
|---|---|
| Italian sausage, cooked, port | 3.0 ounces |
| Mushrooms, raw | 1.25 ounces |

The pizza is prepared according to Example 1, however, before baking, 3.0 ounces of Italian sausage and 1.25 ounces of mushrooms are evenly distributed over the base layer of mozzarella cheese. Then 8 ounces of mozzarella cheese is evenly distributed over all layers. The pizza is then baked as described in Example 1.

NUTRITIONAL FACTS

| Ingredients | Amount of Carbohydrates |
|---|---|
| Italian sausage, cooked, pork | |
| 3.0 ounces | 1.2 grams |
| 4.2 ounce serving of pizza | less than 1 gram |
| Mushrooms, raw | |
| 1.25 ounces | 1.45 grams |
| 4.25 ounce serving of pizza | less than 1 gram |
| TOTAL: | |
| Pizza (prepared) | |
| 4.2 ounce serving of pizza | approx. 3.5 grams-5 |
| | grams |

The exemplary embodiments herein disclosed are not intended to be exhaustive or to unnecessarily limit the scope of the invention. The exemplary embodiments were chosen and described in order to explain the principles of the present invention so that others skilled in the art may practice the invention. As will be apparent to one skilled in the art, various modifications can be made within the scope of the aforesaid description. Such modifications being within the ability of one skilled in the art form a part of the present invention and are embraced by the appended claims.

1. A low carbohydrate food product comprising:
a base layer being a formulated flour and a cheese mixture.

2. The low carbohydrate food product according to claim 1 wherein said formulated flour comprises a high gluten flour and a double acting baking powder.

3. The low carbohydrate food product according to claim 2 wherein a batch of said formulated flour comprises 6 cups of said high gluten flour and 2 tablespoons of said double acting baking powder, mixed thoroughly, wherein said low carbohydrate food product comprises approximately one teaspoon of said batch of said formulated flour.

4. The low carbohydrate food product according to claim 1 wherein said base layer further comprises at least one additional food product.

5. The low carbohydrate food product according to claim 4 wherein said at least one additional food product is selected from the group consisting of meat toppings, poultry toppings, fish toppings, soy enriched meat toppings, vegetables, fruits and any combination thereof.

6. The low carbohydrate food product according to claim 1 further comprising:
at least one food layer, wherein said at least one food layer is selected from the group consisting of cheeses, tomato sauce, meat toppings, poultry toppings, fish toppings, soy enriched meat toppings, vegetables, fruits and any combination thereof.

7. The low carbohydrate food product according to claim 2 wherein said base layer further comprises at least one additional food product.

8. The low carbohydrate food product according to claim 7 wherein said at least one additional food product is selected from the group consisting of meat toppings, poultry toppings, fish toppings, soy enriched meat toppings, vegetables, fruits and any combination thereof.

9. The low carbohydrate food product according to claim 2 further comprising:
at least one food layer, wherein said at least one food layer is selected from the group consisting of cheeses, tomato sauce, meat toppings, poultry toppings, fish toppings, soy enriched meat toppings, vegetables, fruits and any combination thereof.

10. The low carbohydrate food product according to claim 3 further comprising:
at least one food layer, wherein said at least one food layer is selected from the group consisting of cheeses, tomato sauce, meat toppings, poultry toppings, fish toppings, soy enriched meat toppings, vegetables, fruits and any combination thereof.

11. A low carbohydrate crustless pizza comprising:
a base layer being a formulated flour and a cheese mixture; and
at least one food layer.

12. The low carbohydrate crustless pizza according to claim 11 wherein said formulated flour comprises a high gluten flour and a double acting baking powder.

13. The low carbohydrate crustless pizza according to claim 12 wherein a batch of said formulated flour comprises 6 cups of said high gluten flour and 2 tablespoons of said double acting baking powder, wherein said low carbohydrate crustless pizza comprises approximately one teaspoon of said batch of said formulated flour.

14. The low carbohydrate crustless pizza according to claim 11 wherein said base layer further comprises at least one additional food product selected from the group consisting of meat toppings, poultry toppings, fish toppings, soy enriched meat toppings, vegetables, fruits and any combination thereof.

15. The low carbohydrate crustless pizza of claim 11 wherein said at least one food layer is selected from the group consisting of cheeses, tomato sauce, meat toppings, poultry toppings, fish toppings, soy enriched meat toppings, vegetables, fruits and any combination thereof.

16. A method of making a low carbohydrate food product comprising the steps of:
preparing a formulated flour, wherein said formulated flour comprises a high gluten flour and a baking powder;
distributing a pre-measured amount of said formulated flour evenly onto a cooking pan;
distributing a pre-measured amount of a cheese evenly over said formulated flour;
optionally adding and distributing evenly a pre-measured amount of at least one food layer over said cheese; and
baking said low carbohydrate food product for a suitable time and at a suitable temperature.

17. The method of making a low carbohydrate food product according to claim 16 wherein said low carbohydrate food product is baked in a pizza oven or a conventional oven from about 9 minutes to about 13 minutes at about 450° F. to about 525° F.

18. The method of making a low carbohydrate food product according to claim 16, said method further comprising the steps of:
cooling said low carbohydrate food product to where an internal temperature of said low carbohydrate food product is approximately 140° F.;
slicing said low carbohydrate food product into desired portions; and
optionally packaging said low carbohydrate food product.

19. The method of making a low carbohydrate food product according to claim 16 wherein said at least one food layer is selected from the group consisting of cheeses, tomato sauce, meat toppings, poultry toppings, fish toppings, soy enriched meat toppings, vegetables, fruits and any combination thereof.

20. The method of making a low carbohydrate food product according to claim 16, said method further comprising the steps of:
freezing said low carbohydrate food product;
thawing said low carbohydrate food product at some time after freezing; and
reheating said low carbohydrate food product at a low temperature in a suitable heating apparatus.

21. The method of making a low carbohydrate food product according to claim 20 wherein said suitable heating apparatus is selected from the group consisting of microwave oven, pizza oven, conventional gas oven, and conventional electric oven.

22. A method of making a low carbohydrate crustless pizza comprising the steps of:
preparing a formulated flour, wherein said formulated flour comprises a high gluten flour and a baking powder;
distributing a pre-measured amount of said formulated flour evenly onto a cooking pan;
distributing a pre-measured amount of a cheese evenly over said formulated flour;
distributing a pre-measured amount of a pizza sauce or a tomato sauce evenly over said cheese;
adding and distributing evenly a pre-measured amount of at least one food layer over said pizza sauce or said tomato sauce; and
baking said low carbohydrate crustless pizza for a suitable time and at a suitable temperature.

23. The method of making a low carbohydrate crustless pizza according to claim 22 wherein said low carbohydrate crustless pizza is baked in a pizza oven or a conventional oven from about 9 minutes to about 13 minutes at about 450° F. to about 525° F.

24. The method of making a low carbohydrate crustless pizza according to claim 22, said method further comprising the steps of:
cooling said low carbohydrate crustless pizza;
slicing said low carbohydrate crustless pizza into desired portions; and
optionally packaging said low carbohydrate crustless pizza.

25. The method of making a low carbohydrate crustless pizza according to claim 22 wherein said at least one food layer is selected from the group consisting of cheeses, tomato sauce, meat toppings, poultry toppings, fish toppings, soy enriched meat toppings, vegetables, fruits and any combination thereof.

26. The method of making a low carbohydrate crustless pizza according to claim 22, said method further comprising the steps of:
freezing said low carbohydrate crustless pizza;
thawing said low carbohydrate crustless pizza at some time after freezing; and
reheating said low carbohydrate crustless pizza at a low temperature in a suitable heating apparatus.
